(19) United States
(12) Patent Application Publication
(10) Pub. No.: US 2011/0081109 A1
(43) Pub. Date: Apr. 7, 2011

(54) NANOPARTICLE ARRAY PHOTONIC WAVEGUIDE

(76) Inventors: Lars H. Thylen, Huddinge (SE); Alexandre M. Bratkovski, Mountain View, CA (US)

(21) Appl. No.: 12/573,862

(22) Filed: Oct. 5, 2009

(51) Int. Cl. G02B 6/26; G02B 6/10; G02B 6/00

(52) U.S. Cl. 385/30; 385/129; 385/141; 977/773

(57) ABSTRACT

A nanoparticle array photonic waveguide, a photonic transmission system and a method of photonic transmission compensate for optical loss in an optical signal through stimulated emission using an optical gain material in a core of composite nanoparticles. The nanoparticle array photonic waveguide includes a plurality of the composite nanoparticles arranged adjacent to one another in a row. A composite nanoparticle of the plurality includes a shell and a core. The shell includes a negative dielectric constant material that is capable of supporting an optical signal on a surface of the shell. The core is adjacent to a side of the shell opposite to the shell surface. The core includes an optical gain material (OGM) that is capable of providing optical gain to the optical signal through stimulated emission within the OGM.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Development in the area of integrated photonics with applications in optical interconnects, sensors, biotechnology and telecommunications has followed a path similar to that of integrated circuits. The size and costs of integrated photonic components have generally decreased concomitant with a general increase in a complexity and functionality of these components as well as in the photonic systems in which the components are employed. In particular, considerable effort in the past several decades has been devoted to making improvements in all aspects of integrated photonics including reduced size or footprint, increased functionality, lower power dissipation and low cost.

A major advancement in integrated photonics in recent years has been the development and use of so-called “metal optics.” The term “metal optics” here generally refers to the use of optical modes bound or confined to an interface between a surface of a material with a negative dielectric constant (e.g., a metal or a doped semiconductor) and one of a vacuum or a material with a positive dielectric constant. These bound optical modes are also referred to as surface plasmons or surface plasmon polaritons (SPP).

Chief among the promises of metal optics is the use of the bound optical modes in realizing and implementing sub-wavelength photonic devices and structures (e.g., nanoscale integrated photonics). For example, a photonic waveguide comprising a string or array of sub-wavelength metal nanoparticles has been demonstrated. Other extant examples of sub-wavelength or nanoscale integrated photonics include, but are not limited to, the use of metal strips and other generally planar metal surfaces to implement various photonic waveguide and related structures based on metal optics.

Unfortunately, while providing very small-size guiding structures, metal optics including, but not limited to, metal nanoparticle array photonic waveguides, generally suffer from relatively large attenuation or optical loss in a propagating optical signal (i.e., propagation loss). In particular, propagation loss along a length of a metal optics photonic waveguide may effectively limit a usefulness of such a photonic waveguides to only several micrometers or less. While potentially useful in some limited instances where only short distance propagation is required, in general, photonic waveguides that are limited to such sub-micrometer lengths may ultimately prove to be inadequate for many, if not most, practical photonic applications.

### BRIEF DESCRIPTION OF THE DRAWINGS

The various features of embodiments of the present invention may be more readily understood with reference to the following detailed description taken in conjunction with the accompanying drawings, where like reference numerals designate like structural elements, and in which:

FIG. 1 illustrates a top view of a nanoparticle array photonic waveguide, according to an embodiment of the present invention.

FIG. 2 illustrates a cross sectional view of a composite nanoparticle, according to an embodiment of the present invention.

FIG. 3A illustrates a side view of a nanoparticle array photonic waveguide, according to an embodiment of the present invention.

FIG. 3B illustrates a cross sectional view of a nanoparticle array photonic waveguide, according to another embodiment of the present invention.

FIG. 3C illustrates a cross sectional view of a nanoparticle array photonic waveguide, according to yet another embodiment of the present invention.

FIG. 4 illustrates a block diagram of a photonic transmission system, according to an embodiment of the present invention.

FIG. 5 illustrates a flow chart of a method of photonic transmission, according to an embodiment of the present invention.

Certain embodiments of the present invention have other features that are one of in addition to and in lieu of the features illustrated in the above-referenced figures. These and other features of the invention are detailed below with reference to the preceding drawings.

### DETAILED DESCRIPTION

Embodiments of the present invention provide a nanoscale photonic waveguide having optical gain. In particular, according to embodiments of the present invention, nanoparticles are arranged in a row as a nanoparticle array photonic waveguide. The nanoparticles of the nanoparticle array photonic waveguide may be pumped to provide the optical gain, according to various embodiments. In some embodiments, the optical gain compensates for propagation loss in an optical signal of the photonic waveguide. The provided optical gain may facilitate longer propagation lengths than may be possible in other nanoscale photonic waveguides, for example. As such, the nanoparticle array photonic waveguide of the present invention may enable realization of a wide variety of complex photonic devices and systems including, but not limited to, y-junctions, x-junctions, waveguide loop or ring structures, directional couplers, multiplexers and Mach-Zehnder interferometers. Further, the nanoparticles of the nanoparticle array may be individually tuned or otherwise configured to affect realization of frequency dependent or frequency tailored devices such as filters, for example.

According to various embodiments, the nanoparticle array photonic waveguide comprises a plurality of composite nanoparticles. The composite nanoparticles of the plurality are arranged adjacent to one another to form the nanoparticle array photonic waveguide. In some embodiments, the composite nanoparticles are adjacent to one another in a row. In some embodiments, the row comprises the composite nanoparticles arranged singly next to one another. In other embodiments, the composite nanoparticles may be arranged as a row of doublets, triplets, and so on. In yet other embodiments, the row may comprise a plurality of adjacent rows (e.g., parallel ones of a double row, a triple row, etc.) or even in more complex arrangements (e.g., a sheet or 2-dimensional array). As used herein, the term ‘row’ is defined to include both straight rows and curved or curvilinear rows, as described herein and further below. In addition, the definition of ‘row’ further includes rows that have or include a point of inflection or an abrupt change in direction. For example, the row of composite nanoparticles may describe a right bend or a y-junction and still be considered a row.

In operation, an optical signal propagates along the nanoparticle array photonic waveguide from one composite nanoparticle to another. In particular, the composite nanoparticles of the nanoparticle photonic waveguide are optically coupled to one another primarily by near field coupling (e.g., by evanescent fields). A configuration of an optical field of the propagating optical signal is referred to as a mode. The nanoparticle array photonic waveguide may support a plurality of modes of the propagating optical signal. Further, a surface of the composite nanoparticles of the nanoparticle array photonic waveguide supports the propagating optical signal. In particular, the optical signal is effectively bound to the surface of the composite nanoparticle as the optical signal propagates from one composite nanoparticle to another along a length of the nanoparticle array photonic waveguide, according to embodiments of the present invention. In some embodiments, the composite nanoparticle surface supports the propagating optical signal as a surface plasmon. The surface plasmon may be supported on an interface between the composite nanoparticle surface and a dielectric or free space region adjacent to the surface, for example.

According to various embodiments, the composite nanoparticle generally has a major radius that is less than about 100 nanometers (nm). In some embodiments, the major radius of the composite nanoparticle is less than about 50 nm. In some embodiments, the composite nanoparticle has a major radius that is between about 5 nm and about 40 nm (e.g., a major diameter of between 10 nm and 80 nm). For example, the composite nanoparticle may be about 10 nm in diameter (e.g., have a 5 nm major radius). In another example, the composite nanoparticle may have a 10 nm major radius. In another example, a first composite nanoparticle of the nanoparticle array photonic waveguide may have a major radius that differs from a major radius of a second composite nanoparticle of the nanoparticle array photonic waveguide.

According to various embodiments of the present invention, a composite nanoparticle of the nanoparticle array photonic waveguide comprises a shell and a core. A surface of the shell is the surface of the composite nanoparticle and the surface supports the optical signal that propagates on the nanoparticle array photonic waveguide. The core is adjacent to a side of the shell opposite the surface of the shell. In some embodiments, the shell effectively surrounds the core. In other embodiments, the shell may surround only a portion of the core while another portion of the core is not surrounded or even adjacent to the shell.

The shell comprises a negative dielectric constant material (NDM) and the core comprises an optical gain material (OGM). The NDM of the shell supports the propagating optical signal at the shell surface (i.e., the NDM surface). The propagating optical signal couples to the OGM through the shell to produce stimulated emission in the OGM. In turn, the propagating optical signal is amplified by the stimulated emission. Coupling into the OGM occurs through or by way of a portion of an electromagnetic field of the propagating optical signal that penetrates into the core, according to some embodiments. The result is that the propagating signal effectively receives optical energy from the OGM and, as such, experiences optical gain (i.e., is amplified).

In general, a thickness of the shell is designed to facilitate or optimize the coupling between the optical signal propagating on a surface of the shell and an interior of the composite nanoparticle. In some embodiments, a wavelength of operation may be at or substantially detuned from a wavelength of maximum gain in the OGM. In other embodiments, the shell thickness is chosen or designed to facilitate pumping of the OGM. For example, when optical pumping is used, the shell thickness (and perhaps other parameters) may be chosen to insure that sufficient optical energy from an external optical source (i.e., an optical pump) is able to penetrate the shell and pump the OGM of the composite nanoparticle. By ‘sufficient optical energy’ it is meant that the optical energy is sufficient to establish a population inversion in the OGM that enables stimulated emission. In some exemplary embodiments, the shell has a thickness that is generally less than about one half the major radius of the composite nanoparticle. In some embodiments, the shell thickness is less than about 10 nm. In some embodiments, the shell thickness is between about 2 nm and about 10 nm.

Herein, negative dielectric constant material (NDM) is defined as a material that has a dielectric constant that is less than zero. In particular, the NDM is defined as a material with a dielectric constant that is negative valued for at least one frequency. The NDM used for the shell of the composite nanoparticle has a negative dielectric constant at a frequency of the propagating optical signal traveling on the nanoparticle array photonic waveguide of the present invention. For example, the NDM may be a metal such as, but not limited to copper (Cu). In another example, the NDM may be noble metal. For example, the NDM may comprise silver (Ag) or gold (Au). Explicitly included in the definition of NDM herein are composite materials, also known as metamaterials, which exhibit a negative dielectric constant that is one or both of due to a particular combination of materials used to realize the composite material and due to a physical structure (e.g., periodic arrangement) of the materials used.

Herein, the optical gain material (OGM) is defined as a material that provides optical gain to the propagating optical signal. In particular, the OGM provides the optical gain through stimulated emission within the OGM. In general, the OGM may be any material that produces stimulated emission when pumped by one or both of an electrical means (i.e., an electrical pump) and an optical means (i.e., optical pump). As such, candidate materials for the OGM of the core may include any laser material. For example, the OGM may comprise a laser material such as erbium doped silica glass or ruby (i.e., chromium doped aluminum oxide).

In some embodiments, the OGM may comprise a semiconductor. In general, both semiconductors that exhibit a direct band gap and semiconductors that exhibit an indirect bandgap may be used. However, direct bandgap semiconductors may produce much higher optical gain, according to some embodiments. In some embodiments, the semiconductor may be undoped (e.g., effectively intrinsic) or doped such that no semiconductor junction is present. In some of these embodiments, heterostructures may be employed. A heterostructure is a layered semiconductor that comprises layers of different semiconductor materials (e.g., see discussion below). In other embodiments, the semiconductor may be doped to form a semiconductor junction (e.g., a diode junction). For example, the semiconductor junction may be biased by an electrical source (i.e., the electrical pump) to provide stimulated emission when coupled to the propagating optical signal through the shell. In some embodiments, the semiconductor junction may employ a homojunction (i.e., using the same materials), while in other embodiments, a heterjunction (e.g., a quantum well structure) may be used. Examples of semiconductors that may be used as either a homojunction or a heterojunction to form the OGM include, but are not limited to, gallium arsenide (GaAs), indium gallium arsenide (InGaAs), and gallium nitride (GaN), as well as various other III-V, II-VI, and IV-VI compound semiconductors. Optical pumping may be used instead of or in addition to electrical pumping when the OGM comprises a semiconductor (e.g., with or without a semiconductor junction), according to some embodiments.

In some embodiments, the OGM of the core is a heterostructure semiconductor. In particular, the core may comprise a first layer comprising a first semiconductor having a first bandgap and a second layer comprising a second semiconductor having a second bandgap that is larger than the first bandgap. The second layer is located between the first layer and the shell. For example, the first layer may be an inner or central portion of the core and the second layer may either partially or completely surround the first layer. In other words, the first layer is effectively an inner core and the second layer is an outer core. The smaller or narrower bandgap of the first semiconductor material forms a potential well due to the bandgap difference. Excitons generated in the second semiconductor material may easily drift into the potential well. Moreover, photons generated by exciton annihilation within the first semiconductor during stimulated emission are not easily absorbed by the second semiconductor material and will pass more easily therethrough enhancing the optical gain. Exemplary materials for the first/second semiconductors include, but are not limited to, cadmium selenide/zinc sulfide (CdSe/ZnS), cadmium telluride/zinc sulfide (CdTe/ZnS), cadmium sulfide/zinc sulfide (CdS/ZnS), lead selenide/lead sulfide (PbSe/PbS), indium phosphide/zinc sulfide (InP/ZnS), indium arsenide/cadmium selenide (InAs/CdSe, indium arsenide/indium phosphide (InAs/InP), indium arsenide/gallium arsenide (InAs/GaAs) and silicon/silicon dioxide (Si/SiO₂).

In other embodiments, the core comprises a material that provides stimulated emission, or equivalently may be induced into a state of population inversion, when exposed to an external optical signal from an optical pump. For example, various crystalline materials doped with either transition metal ions or rare-earth ions may be employed. Neodymium may be used to dope yttrium lithium fluoride (Nd:YLF), yttrium aluminum garnet (Nd:YAG) and yttrium orthovanadate (Nd:YVO₄), for example. Chromium may be used to dope corundum (i.e., aluminum oxide or Al₂O₃) to produce a ruby (Cr:Al₂O₃) and titanium may be used to dope sapphire (Ti:sapphire or Ti:Al₂O₃) for use as the OGM, for example.

In some embodiments, the composite nanoparticle further comprises an insulator layer between the shell and the core. The insulator layer comprises an insulator material and provides electrical insulation between the shell and the core. As defined herein, an insulator material explicitly includes any material that is generally more insulative than conductive. In other words, materials other than pure or ideal insulators may be employed to realize the insulator layer, according to the definition employed herein. For example, the insulator material may comprise a dielectric material. In another example, the insulator material may comprise a relatively resistive material such as an intrinsic or lightly doped semiconductor.

In various embodiments, a material of the insulator layer may be an oxide, a carbide, a nitride or an oxynitride of any of the above-referenced semiconductor materials such that insulating properties of the material are facilitated. For example, the insulator may be a silicon oxide (SiOₓ). Alternatively, the insulator may comprise an oxide, a carbide, a nitride or an oxynitride of a metal (e.g., aluminum oxide) or even a combination of multiple, different materials to form a single insulating material or it may be formed from multiple layers of insulating materials.

Herein, the term ‘pump’ is explicitly defined as a source of energy used to induce population inversion in the OGM. Specifically, the pump provides energy to the OGM which raises electrons of the OGM to a higher energy state (e.g., excitons). The higher energy state electrons in the OGM eventually decay by way of one or both of spontaneous emission and stimulated emission, in addition to possible nonradiative recombination (e.g., as phonons and/or as an Auger electron). An optical pump provides the energy to the OGM primarily through an optical means (e.g., light or electromagnetic radiation) while an electrical pump provides the energy primarily through an electrical means (e.g., an electric current). Generally, the pump that provides the energy to pump the OGM is separate from a source that provides the propagating optical signal, according to some embodiments.

Herein, the term “major radius” is defined as a radius of a circle that contains a nanoparticle or a selected cross section of the nanoparticle. In particular, the major radius defines a circle that contains a cross section of the nanoparticle, wherein the cross section is taken in a direction of propagation of the optical signal. For example, the major radius of a nanoparticle having a spherical shape is a radius of a sphere that contains the nanoparticle. Similarly, for an exemplary nanoparticle having a hemispherical shape, the major radius is also a radius of a sphere that contains the nanoparticle. Exemplary nanoparticles being cube-shaped have a major radius corresponding to a radius of a sphere that contains the cube-shaped nanoparticle. For an exemplary nanoparticle having a rod-like shape (i.e., having one dimension that is much greater than two other dimensions), the major radius is defined as a radius of a circle that contains a cross section of the nanoparticle, wherein the cross section is taken perpendicular to an axis of the rod-like shaped nanoparticle. Likewise, a nanoparticle having the shape of a pyramid would have a major radius that corresponds to a radius of a circle that enclosed a widest cross section of the nanoparticle perpendicular to an axis of the pyramidal shape extending from a tip of the pyramid to a base thereof. A “major diameter” is defined as two times the major radius.

A ‘semiconductor junction’ as used herein refers to a junction formed within a semiconductor material between two differently doped regions thereof. For example, a junction between a p-doped region and an n-doped region of the semiconductor material is referred to as a p-n semiconductor junction or simply a p-n junction. The p-n junction includes asymmetrically doped semiconductor junctions such as, but not limited to, p⁺-n junctions where ‘p⁺’ denotes a relatively higher concentration of the p-type dopant or impurity compared to the n-type dopant or impurity. A semiconductor junction in which an intrinsically doped region (i-region) lies between and separates the p-doped region (or ‘p-region’) and the n-doped region (or ‘n-region’) is generally referred to herein as a p-i-n semiconductor junction or simply a p-i-n junction. The term ‘semiconductor junction’ as used herein also refers to complex junctions that may include one or more of layers of different semiconductor materials (e.g., GaAs and GaAlAs), layers of different doping concentrations (e.g., p, p⁺, p⁻, p⁺⁺, n, n⁺, n⁻, n⁺⁺, i, etc.), and doping concentration gradients within and across layers. Further herein, an ‘intrinsically’ doped semiconductor or a related ‘intrinsic’ region/layer/semiconductor is defined as a semiconductor or semiconductor region having a doping concentration that is either undoped (e.g., not intentionally doped) or relatively lightly doped when compared to doping concentrations present in other layers or regions of the semiconductor junction (e.g., p-doped regions or n-doped regions).

Semiconductor junctions that join different semiconductor materials are defined and referred to herein as either ‘heterostructure junctions’ or simply ‘heterojunctions’. For example, a layer of a first semiconductor material sandwiched between two adjacent layers of a second semiconductor material would be referred to as a heterojunction. Such a heterojunction, wherein the first semiconductor material has a first bandgap and the second semiconductor material has a second band gap, the first bandgap being lower than the second bandgap, is defined herein as a quantum well or a heterojunction quantum well. By way of distinction, a ‘heterostructure’ is defined herein as a structure comprising a plurality of different semiconductor materials arranged in adjacent layers where the adjacent layers are in intimate contact with one another.

Herein, no distinction is made between various specific types of junctions (e.g., p-n, p-i-n, p⁺-n, p⁺-⁻n, heterojunction, etc.) unless such distinction is necessary for proper understanding. Semiconductor junctions between an n-type semiconductor and a p-type semiconductor (of the same or of a different material) are also often referred to as ‘diode junctions’ whether or not an intrinsic layer separates the n-type doped and p-type doped semiconductors.

A surface plasmon is defined herein as a surface wave or plasma oscillation of a two dimensional free electron gas (2DEG) at a surface of a plasmon supporting material. The surface plasmon may also be considered as a quasiparticle representing a quantization of a plasma oscillation in a manner analogous to the representation of an electromagnetic oscillation quantization as a photon. For example, collective oscillations of 2DEG in a surface of a noble metal induced by an incident electromagnetic wave at optical frequencies may be represented in terms of surface plasmons. Furthermore, characteristics of surface plasmons may be referred to in terms of plasmonic modes. In particular, plasmonic modes represent characteristics of surface plasmons in much the same way that electromagnetic oscillations are represented in terms of electromagnetic or optical modes.

Surface plasmons and by extension, plasmonic modes, are confined to a surface of a material that supports surface plasmons. For example, an optical signal incident from a vacuum or a dielectric material on a surface of a surface plasmon supporting material may produce surface plasmons that propagate along the surface according to plasmonic modes.

Further, as used herein, the article ‘a’ is intended to have its ordinary meaning in the patent arts, namely ‘one or more’. For example, ‘a semiconductor’ means one or more semiconductors and as such, ‘the semiconductor’ means ‘the semiconductor(s)’ herein. Also, any reference herein to ‘top’, ‘bottom’, ‘upper’, ‘lower’, ‘up’, ‘down’, ‘front’, back', ‘left’ or ‘right’ is not intended to be a limitation herein. Herein, the term ‘about’ when applied to a value generally means plus or minus 10% unless otherwise expressly specified. Moreover, examples herein are intended to be illustrative only and are presented for discussion purposes and not by way of limitation.

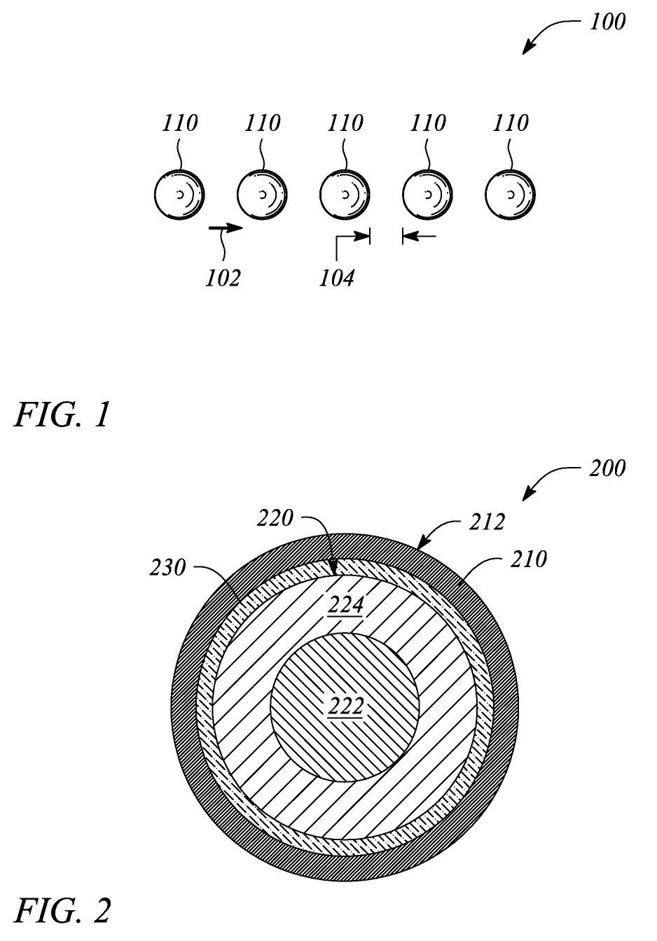

FIG. 1 illustrates a top view of a nanoparticle array photonic waveguide 100, according to an embodiment of the present invention. The nanoparticle array photonic waveguide 100 comprises a plurality of composite nanoparticles 110 arranged adjacent to one another in a row. As illustrated, the row is straight. As defined herein and above, the term ‘row’ is intended to include within its scope a curved row (i.e., a curvilinear row), a branched row and a forked row, according to various other embodiments (not illustrated). An optical signal 102 propagating along the photonic waveguide 100 is bound to individual ones of the composite nanoparticles 110 in the plurality such that the propagating optical signal 102 effectively follows, or is guided by, the plurality of composite nanoparticles 110 that make up the nanoparticle array photonic waveguide 100. A heavy arrow in FIG. 1 indicates a direction of propagation of the optical signal 102.

In some embodiments, the composite nanoparticle 110 has a major diameter of between about 10 nanometers (nm) and about 100 nm. Further in some embodiments, the composite nanoparticles 110 of the nanoparticle array photonic waveguide 100 are spaced apart from one another along an extent of the nanoparticle array photonic waveguide 100, as illustrated in FIG. 1. In some embodiments, a spacing or gap 104 between two adjacent composite nanoparticles 110 is less than about two times a major diameter (or four times a major radius) of the composite nanoparticles 110. In some embodiments, the gap 104 is less than about 100 nm.

For example, if composite nanoparticles 110 of an adjacent pair each have a generally spherical shape with a diameter of about 10 nm, the gap 104 may be 10 nm. A gap 104 of 10 nm is less than about 20 nm or two times the major diameter of the spherically shaped composite nanoparticles 110, for example. In another example, where the major diameter of two adjacent composite nanoparticles 110 is about 20 nm, the gap 104 may be about 5 nm. In some embodiments, the gap 104 may vary along a length of the nanoparticle array photonic waveguide 100.

Moreover, the gap 104 may vary even though a major diameter of the composite nanoparticles 110 of the plurality is effectively constant. In other embodiments, the gap 104 may be effectively constant while a major diameter of the composite nanoparticles 110 of the plurality varies. In yet other embodiments, the gap 104 between one or more of the composite nanoparticles 110 of the plurality may be effectively 0 nm such that adjacent composite nanoparticles 110 effectively touch one another.

FIG. 2 illustrates a cross sectional view of a composite nanoparticle 200, according to an embodiment of the present invention. In particular, the composite nanoparticle 200 has a spherical shape and the cross section is taken through a center of the spherically shaped composite nanoparticle 200, as illustrated in FIG. 2. Moreover, while having an exemplary spherical shape as illustrated, the embodiment of the composite nanoparticle 200 of FIG. 2 may be considered illustrative of various features of many other composite nanoparticles, according to the present invention, when viewed in cross section through a center or central region thereof. In some embodiments, the composite nanoparticle 200 illustrated in FIG. 2 is an embodiment of the composite nanoparticle 110 of the plurality that makes up the nanoparticle array photonic waveguide 100 illustrated in FIG. 1.

As illustrated, the composite nanoparticle 200 comprises a shell 210, a surface of which supports or is capable of supporting an optical signal. For example, the supported signal may be the optical signal 102 propagating along the nanoparticle array photonic waveguide 100 as illustrated in FIG. 1. Specifically, the optical signal is supported on a surface 212 of the shell 210. The shell 210 comprises a relatively thin layer of material when compared to the major radius of the composite nanoparticle 200. For example, the shell 210 may be between about 2 nm and 4 nm thick for a composite nanoparticle 200 having a major radius that is about 10 nm.

The shell 210 comprises a negative dielectric constant material (NDM). The NDM has a negative dielectric constant for at least one frequency within a frequency range of the optical signal, according to various embodiments. In some embodiments, the NDM comprises a metal or a metal alloy. For example, the metal may be copper (Cu). In some embodiments, the metal comprises a noble metal. For example, the noble metal may be either gold (Au) or silver (Ag). In other embodiments, the NDM comprises another material in addition to or instead of a metal. For example, the NDM may comprise a metamaterial.

The composite nanoparticle 200 further comprises a core 220. The core 220 is adjacent to a side of the shell 210 opposite the surface 212 that supports the optical signal. The core 220 comprises optical gain material (OGM). The OGM provides or is capable of providing optical gain to the optical signal through stimulated emission within the OGM. In particular, coupling between the optical signal and the OGM may induce the stimulated emission.

Referring to the embodiment illustrated in FIG. 2, the core 220 of the composite nanoparticle 200 comprises a first layer 222. The first layer 222 comprises a semiconductor material having a first bandgap. The core 220 further comprises a second layer 224. The second layer 224 comprises a second semiconductor material having a bandgap that is larger than the first bandgap. The second layer 224 is located between the first layer 222 and the shell 210. In particular, as illustrated for the generally spherical composite nanoparticle 200, the second layer 224 effectively surrounds the first layer 222. The first layer 222 and the second layer 224 collectively form the OGM of the core 220 that provides optical gain to the optical signal through stimulated emission. In some embodiments, the bandgap difference between the first layer 222 and the second layer 224 may enhance the stimulated emission by effectively forming a potential well, as is discussed in more detail above. A combined structure including the first layer 222 and the second layer 224 may be generally referred to as a quantum dot (QD).

In some embodiments, including the embodiment illustrated in FIG. 2, the composite nanoparticle further comprises an insulator layer 230. In some embodiments, the insulator layer 230 is located between the core 220 and the shell 210. The insulator layer 230, when present, electrically insulates the core 220 from the shell 210. In some embodiments, the insulator layer 230 comprises a dielectric material. For example, the insulator layer 230 may comprise an oxide or a nitride of a semiconductor of the core 220. In another example, the insulator layer 230 may comprise an undoped semiconductor (e.g., an intrinsic semiconductor). In other embodiments, the insulator layer 230 comprises a resistive material that allows some electric current to flow between the core 220 and the shell 210 (e.g., a lightly doped semiconductor).

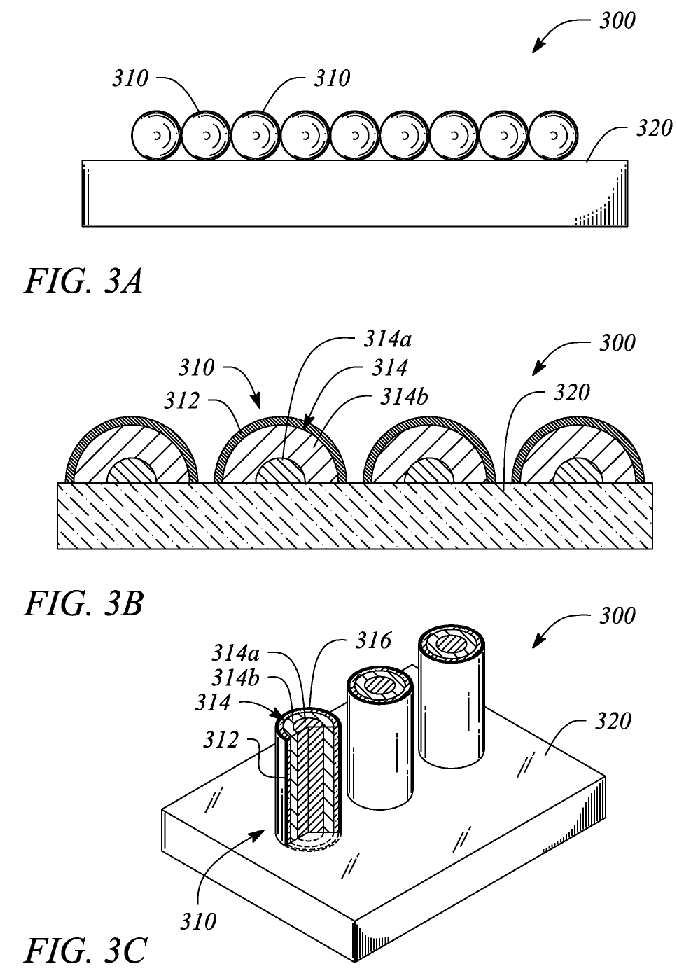

FIG. 3A illustrates a side view of a nanoparticle array photonic waveguide 300, according to an embodiment of the present invention. In particular, the nanoparticle array photonic waveguide 300 illustrated in FIG. 3A comprises a plurality of composite nanoparticles 310 situated on a surface of a substrate 320. In some embodiments, the substrate 320 comprises an insulator material. For example, the substrate 320 may be an insulator on semiconductor substrate comprising an insulator layer at a top surface of the substrate 320. The composite nanoparticles 310, as illustrated, have a spherical shape and may be effectively similar to the composite nanoparticle 200 illustrated in FIG. 2, for example. Further, as illustrated in FIG. 3A, the composite nanoparticles 310 are touching one another and thus have a gap of about 0 nm between adjacent composite nanoparticles 310, by way of example.

FIG. 3B illustrates a cross sectional view of a nanoparticle array photonic waveguide 300, according to another embodiment of the present invention. In particular, the nanoparticle array photonic waveguide 300 illustrated in FIG. 3B comprises a plurality of composite nanoparticles 310 situated on a surface of the substrate 320. The composite nanoparticles 310 of the plurality, as illustrated, have a hemispherical shape. Further, as illustrated, each of the hemispherically shaped composite nanoparticles 310 comprises a shell 312 and a core 314. The core 314 comprises a first layer 314a and a second layer 314b. The first layer 314a is located at or near a center of the hemispherically shaped composite nanoparticle 310. The second layer 314b is situated between the first layer 314a and the shell 312. The shell 312 is radially adjacent to the core 314. No insulator layer is present in the composite nanoparticles 310 illustrated in FIG. 3B, by way of example.

The shell 312 comprises an NDM (e.g., a metal) while the core 314 comprises an OGM. For example, the first layer 314a and second layer 314b may comprise a first semiconductor and a second semiconductor, respectively. The first semiconductor may have a smaller or narrower bandgap than a bandgap of the second semiconductor, for example.

In some embodiments, the hemispherically shaped composite nanoparticle 310 may be similar to the composite nanoparticle 200 illustrated in FIG. 2, albeit cut in half. Specifically, the first layer 314a and second layer 314b may be effectively similar to the first layer 222 and second layer 224 described above with respect to the composite nanoparticle 200, illustrated in FIG. 2. Likewise, the shell 312 may be effectively similar to the shell 210 of the composite nanoparticle 200.

FIG. 3C illustrates a perspective view of a nanoparticle array photonic waveguide 300, according to another embodiment of the present invention. In particular, the nanoparticle array photonic waveguide 300 illustrated in FIG. 3C comprises a plurality of rod-shaped composite nanoparticles 310. The nanoparticle array photonic waveguide 300 further comprises a substrate 320. The rod-shaped composite nanoparticles 310 extend from a surface of the substrate 320 with one end attached to the substrate 320, as illustrated. For example, the rod-shaped composite nanoparticles 310 may be formed from or as core/shell nanowires grown or otherwise formed on the substrate 320.

Further as illustrated in FIG. 3C, one of the rod-shaped composite nanoparticles 310 is illustrated in cross section to reveal interior structural details. The rod-shaped composite nanoparticles 310 comprise a generally rod-shaped core 314 surrounded by a shell 312. The core 314, in turn, comprises a first layer 314a surrounded by a second layer 314b. The first layer 314a and second layer 314b may be similar to the first layer 222 and the second layer 224, respectively, described above with reference to the composite nanoparticle 200 illustrated in FIG. 2, according to some embodiments. Also illustrated is an insulator layer 316 between the second layer 314b and the shell 312, by way of example.

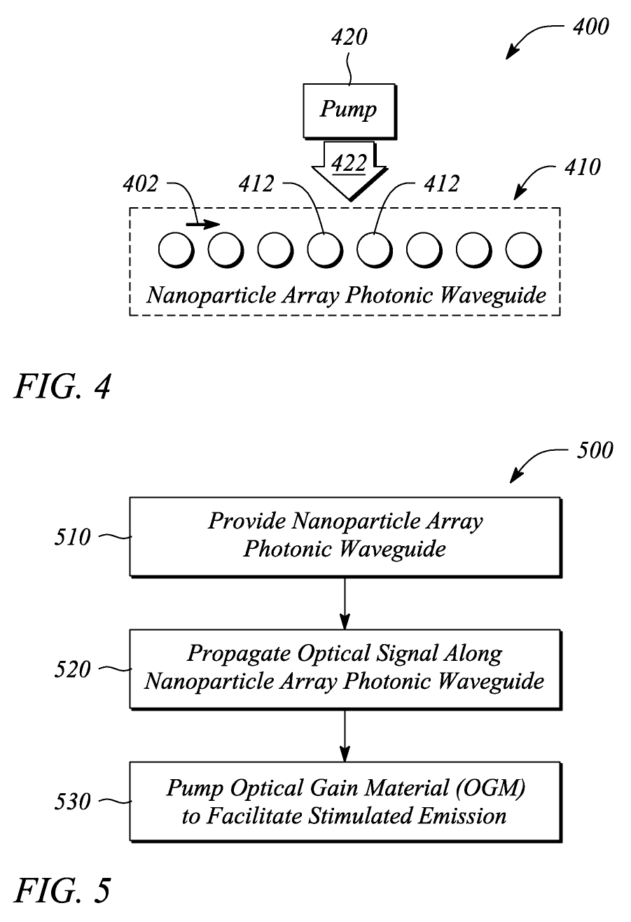

FIG. 4 illustrates a block diagram of a photonic transmission system 400, according to an embodiment of the present invention. As illustrated, the photonic transmission system 400 comprises a nanoparticle array photonic waveguide 410. The nanoparticles array photonic waveguide 410 comprises a plurality of composite nanoparticles 412 arranged adjacent to one another in a row. The composite nanoparticles 412 of the plurality support an optical signal 402 that propagates along an extent of the nanoparticle array photonic waveguide 410.

The composite nanoparticles 412 comprise a shell and a core (both not specifically illustrated in FIG. 4). The core is adjacent to a side of the shell opposite a surface of the shell that supports or that is capable of supporting the propagating optical signal 402. The shell comprises a negative dielectric constant material (NDM). In some embodiments, the NDM is only at a surface of the shell. In some embodiments, the NDM comprises a metal. In some embodiments, the metal comprises a noble metal such as, but not limited to silver (Ag) or gold (Au). The core comprises an optical gain material (OGM). The OGM of the core provides or is capable of providing optical gain to the optical signal 402 through stimulated emission. In some embodiments, the nanoparticle array photonic waveguide 410 is similar to the nanoparticle array photonic waveguide 100 described above with respect to FIG. 1. Further, the composite nanoparticle 410 may be similar to any of the composite nanoparticles 110, 200, 310 described above with respect to FIGS. 1, 2 and 3A-3C, according to some embodiments.

The photonic transmission system 400 further comprises a pump 420. The pump 420 is capable of providing energy 422 to pump the plurality of composite nanoparticles 412 of the nanoparticle array photonic waveguide 410. Pumping the composite nanoparticles 412, in turn, enables the stimulated emission that provides gain to the optical signal 402. The optical gain provided by pumping the composite nanoparticles 412 may compensate for a propagation loss in the optical signal 402 propagating along the nanoparticle array photonic waveguide 410 of the photonic transmission system 400.

In some embodiments, the pump 420 comprises an optical pump 420. For example, the optical pump 420 may comprise a light source adjacent to the nanoparticle array photonic waveguide 410. The light source based optical pump 420 provides optical energy that effectively passes through the shell of the composite nanoparticles 412 to induce population inversion and facilitate stimulated emission within the OGM of the core, for example. Effectively any optical pump used for producing lasers may be employed as the optical pump 420. For example, the optical pump 420 may comprise a laser arranged to illuminate the nanoparticle array photonic waveguide 410.

In some embodiments, the pump 420 comprises an electrical pump 420. The electrical pump 420 may be an electrical voltage source or an electrical current source, for example. The electrical pump 420 may be connected to the core of the composite nanoparticles 412, in some embodiments. For example, the electrical pump 420 may be connected to bias a semiconductor junction of the core. In other embodiments, the electrical pump 420 may be connected to both the core and the shell. For example, the shell may act as one of a pair of electrodes used to bias a semiconductor junction of the core and a first layer of the core may be directly contacted to act as the other electrode of the pair of electrodes to bias the semiconductor junction.

FIG. 5 illustrates a flow chart of a method of photonic transmission, according to an embodiment of the present invention. The method 500 of photonic transmission compensates for loss in a propagating optical signal. In particular, the method 500 of photonic transmission compensates for loss induced in the propagating signal due to interaction with a photonic waveguide. The loss is compensated for by optical gain provided by the photonic waveguide embodiments of the present invention through stimulated emission within elements of the photonic waveguide.

The method 500 of photonic transmission comprises providing 510 a nanoparticle array photonic waveguide. The nanoparticle array photonic waveguide comprises a plurality of composite nanoparticles arranged adjacent to one another. A composite nanoparticle of the plurality comprises a shell. The shell comprises a negative dielectric constant material (NDM), wherein a surface of the shell NDM supports the optical signal. The composite nanoparticle further comprises a core adjacent to a side of the shell opposite to the surface of the shell. The core comprises an optical gain material (OGM). In various embodiments, the provided 510 nanoparticle array photonic waveguide is effectively similar to the nanoparticle array photonic waveguide 100 described above with respect to FIG. 1. Further, the composite nanoparticles of the provided 510 nanoparticle array photonic waveguide may be effectively similar to any of the composite nanoparticles 110, 200, 310 described above with respect to FIGS. 1, 2 and 3A-3C, according to various embodiments.

In some embodiments, providing 510 a nanoparticle array photonic waveguide comprises providing the plurality of composite nanoparticles, wherein each of the composite nanoparticles has a major diameter between about 10 nm and 100 nm. Providing 510 a nanoparticle array photonic waveguide may further comprise arranging the provided plurality of composite nanoparticles adjacent to one another in a row, as described above. In some embodiments, the composite nanoparticles of the plurality are spaced apart from one another in the row by a gap that is less than about twice a largest major diameter of the composite nanoparticles in the plurality. In other embodiments, the composite nanoparticles are arranged such that they physically contact adjacent ones of the composite nanoparticles in the row. The composite nanoparticles may be arranged in the row on a substrate, for example.

The method 500 of photonic transmission further comprises propagating 520 the optical signal along the nanoparticle array photonic waveguide. Propagating 520 the optical signal may comprise coupling the optical signal onto a first one of the composite nanoparticles of the photonic waveguide, for example. Propagating 520 the optical signal may further comprise coupling the optical signal from the first one of the composite nanoparticles to successive adjacent ones of the composite nanoparticles of the photonic waveguide. Coupling the optical signal may be facilitated by spacing adjacent composite nanoparticles by the gap that is less than about twice the largest major diameter of the composite nanoparticles in the plurality that make up the nanoparticle array photonic waveguide.

The method 500 of photonic transmission further comprises pumping 530 the OGM of the composite nanoparticles to facilitate stimulated emission within the OGM. In some embodiments, pumping 530 the OGM comprises optical pumping. In other embodiments, pumping 530 the OGM comprises electrical pumping. In yet other embodiments, pumping 530 the OGM may comprise both optical pumping and electrical pumping.

Thus, there have been described embodiments of a nanoparticle array photonic waveguide, a photonic transmission system and a method of photonic transmission that compensate for optical loss in a propagating optical signal by providing optical gain through stimulated emission using composite nanoparticles. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

What is claimed is:

1. A nanoparticle array photonic waveguide comprising:
a plurality of composite nanoparticles, a composite nanoparticle of the plurality comprising:
a shell comprising a negative dielectric constant material (NDM) that is capable of supporting an optical signal on a surface of the shell; and
a core adjacent to a side of the shell opposite to the shell surface, the core comprising an optical gain material (OGM) that is capable of providing optical gain to the optical signal through stimulated emission within the OGM,
wherein the composite nanoparticles of the plurality are arranged adjacent to one another in a row that forms the nanoparticle array photonic waveguide.

2. The nanoparticle array photonic waveguide of claim 1, wherein the core comprises:
a first layer that comprises a semiconductor material having a first bandgap; and
a second layer that comprises a second semiconductor material having a second bandgap that is larger than the first bandgap, the second layer being between the first layer and the shell,
wherein the first semiconductor material and the second semiconductor material together form the OGM of the core.

3. The nanoparticle array photonic waveguide of claim 1, further comprising an insulator layer that is between the core and the shell, the insulator layer electrically insulating the core from the shell.

4. The nanoparticle array photonic waveguide of claim 1, wherein the NDM of the shell comprises a noble metal.

5. The nanoparticle array photonic waveguide of claim 4, wherein the noble metal comprises one of silver (Ag) and gold (Au).

6. The nanoparticle array photonic waveguide of claim 1, wherein the composite nanoparticles of the plurality are spaced apart from one another in the row by a gap that is less than about two times a major diameter of the composite nanoparticles.

7. The nanoparticle array photonic waveguide of claim 1, wherein the composite nanoparticle has a major diameter of between about 10 nanometers and about 100 nanometers.

8. The nanoparticle array photonic waveguide of claim 1, further comprising a pump that pumps the OGM of the core to compensate for optical loss in an optical signal that is propagated along the nanoparticle array photonic waveguide.

9. The nanoparticle array photonic waveguide of claim 8, wherein the pump comprises an optical pump.

10. The nanoparticle array photonic waveguide of claim 8, wherein the pump comprises an electrical pump, the OGM comprising a semiconductor junction.

11. The nanoparticle array photonic waveguide of claim 1, wherein the composite nanoparticle has one of a spherical shape, a hemispherical shape and a rod shape, the shell radially adjacent to the core.

12. A photonic transmission system, the system comprising:
a nanoparticle array photonic waveguide that comprises a plurality of composite nanoparticles arranged adjacent to one another, a composite nanoparticle of the plurality comprising:
a shell that comprises a negative dielectric constant material (NDM); and
a core adjacent to a side of the shell opposite a surface of the shell capable of supporting an optical signal, the core comprising an optical gain material (OGM) capable of providing optical gain to the optical signal through stimulated emission; and
a pump that is capable of providing energy to pump the plurality of composite nanoparticles and to enable the stimulated emission.

13. The photonic transmission system of claim 12, wherein the NDM of the shell comprises a noble metal.

14. The photonic transmission system of claim 12, wherein the core comprises:
a first layer comprising a semiconductor material having a first bandgap; and
a second layer comprising a second semiconductor material having a second bandgap that is smaller than the first bandgap, the second layer being between the first layer and the shell,
wherein the first semiconductor material and the second semiconductor material together form the OGM of the core.

15. The photonic transmission system of claim 12, further comprising an insulator layer that is between the core and the shell, the insulator layer electrically insulating the core from the shell.

16. The photonic transmission system of claim 12, wherein the pump comprises an optical pump to enable the stimulated emission in the OGM.

17. The photonic transmission system of claim 12, wherein the composite nanoparticle has a major diameter of between about 10 nanometers and about 100 nanometers, and wherein the composite nanoparticles of the plurality are spaced apart from one another by a gap that is less than about two times the major diameter of the composite nanoparticles.

18. A method of photonic transmission that compensates for loss in an optical signal, the method comprising:
providing a nanoparticle array photonic waveguide having a plurality of composite nanoparticles arranged adjacent to one another, a composite nanoparticle of the plurality comprising:
a shell that comprise a negative dielectric constant material (NDM), a surface of the shell NDM supporting the optical signal; and
a core adjacent to a side of the shell opposite the surface, the core comprising an optical gain material (OGM);
propagating the optical signal along the nanoparticle array photonic waveguide; and
pumping the OGM to facilitate stimulated emission within the OGM,
wherein the stimulated emission provides optical gain to the optical signal, the optical gain compensating for the loss in the propagating optical signal.

19. The method of photonic transmission of claim 19, wherein providing a nanoparticle array photonic waveguide comprises:
providing the plurality of composite nanoparticles, each of the composite nanoparticles having a major diameter between about 10 nanometers and 100 nanometers; and
arranging the composite nanoparticles of the plurality in a row spaced apart from one another by a gap that is less than about twice a largest major diameter of the composite nanoparticles.

20. The method of photonic transmission of claim 19, wherein the core comprises:
an inner layer comprising a first semiconductor material;
an outer layer located between the inner layer and the shell, the outer layer comprising a second semiconductor material having a bandgap that is larger than a bandgap of the first semiconductor material; and
an insulator layer located between the outer layer and the shell, the insulator layer comprising a dielectric material,
wherein the OGM comprises the inner layer and the outer layer of the core, and wherein the insulator layer electrically insulates the OGM from the shell.
